(19) United States
(12) Patent Application Publication
(10) Pub. No.: US 2026/0304380 A1
(43) Pub. Date: Oct. 1, 2026

(54) MONITORING PROCESSES FOR AI-BASED POSITIONING

(71) Applicant: Apple Inc., Cupertino, CA (US)

(72) Inventors: Oghenekome Oteri, San Diego, CA (US); Haitong Sun, Cupertino, CA (US); Wei Zeng, Saratoga, CA (US); Dawei Zhang, Saratoga, CA (US); Weidong Yang, San Diego, CA (US); Huaning Niu, San Jose, CA (US)

(21) Appl. No.: 19/479,402

(22) PCT Filed: Mar. 21, 2024
(86) PCT No.: PCT/US2024/020845

§ 371 Date: Oct. 28, 2025

Related U.S. Application Data
(60) Provisional application No. 63/501,948, filed on May 12, 2023.

(51) Int. Cl. H04W 64/00; H04L 41/16; H04W 24/02

(52) U.S. Cl. CPC H04W 64/006; H04L 41/16; H04W 24/02

(57) ABSTRACT

Systems, methods, and circuitries are provided for monitoring performance of an artificial intelligence/machine learning model used for positioning assistance. A device is provided that includes a memory and a processor coupled to the memory. The processor configured to, when executing instructions stored in the memory, receive a monitoring KPI derived from AI/ML data associated with an AI/ML model used for AI-assisted positioning; compare the monitoring KPI to a reference KPI; and based on the comparison, perform one or more monitoring actions.

### BACKGROUND

The present disclosure relates generally to wireless communication and more specifically to techniques for supporting location services for user equipments (UEs).

### BRIEF DESCRIPTION OF THE DRAWINGS

Some examples of circuits, apparatuses and/or methods will be described in the following by way of example only. In this context, reference will be made to the accompanying figures.

FIG. 1 is a diagram of an example of user equipment (UE), base stations (BS), core network, and artificial intelligence/machine learning management function (AI/ML-MF) server, in accordance with various aspects described.

FIG. 2 is table outlining example characteristics of AI-based UE positioning, in accordance with various aspects described.

FIG. 3 is a diagram of an example neural network (NN), in accordance with various aspects described.

FIG. 4 is a functional block diagram of an example system for generating an AI/ML based positioning-related inference output, in accordance with various aspects described.

FIG. 5 illustrates an example message sequence for configuring and performing collection of AI/ML model data, in accordance with various aspects described.

FIG. 6 is a message flow diagram outlining an example method for monitoring performance of an AI/Ml model based on measurement inputs, in accordance with various aspects described.

FIG. 7 is a message flow diagram outlining an example method for monitoring performance of an AI/Ml model based on model output statistics, in accordance with various aspects described.

FIG. 8 is a message flow diagram outlining an example method for monitoring performance of an AI/Ml model based on model output and a ground truth value, in accordance with various aspects described.

FIG. 9 is a message flow diagram outlining an example method for monitoring performance of an AI/Ml model based on model output and a ground truth value, in accordance with various aspects described.

FIG. 10 is a flow diagram outlining an example method for monitoring performance of an AI/Ml model based on model output and a ground truth value, in accordance with various aspects described.

FIG. 11 is a flow diagram outlining an example method causing transmission of reference signals used to generate measurement data, in accordance with various aspects described.

FIG. 12 is a flow diagram outlining an example method for determining a monitoring key performance characteristic, in accordance with various aspects described.

FIG. 13 is a flow diagram outlining an example method for monitoring performance of an AI/Ml model based on model output and a ground truth value, in accordance with various aspects described.

FIG. 14 illustrates a simplified block diagram of a network device, in accordance with various aspects described.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. Similar reference characters may refer to similar aspects within the figures. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

In a wireless communication system, information about a location or position of a UE is used for many aspects including cell handovers, navigation services, location enhanced web browsing, and so on. FIG. 1 illustrates an exemplary wireless communication system 100 that includes a UE 110, a positioning reference unit (PRU) 115, a Radio Access Network (RAN) having a plurality of base stations 120, and a core network (CN) having an Access and Mobility Management Function (AMF) 130 that communicates with Location Management Function (LMF) 135. The AMF 130 and LMF 135 may be implemented on a server(s) associated with the CN. It is noted that, in other examples, the communication system may include an Access Network (AN) in which devices communicate using Wireless Local Area Network (WLAN) protocols and interfaces instead of, or in addition to, NG-RAN or LTE cellular protocols.

The LMF 135 provides AI/ML model-enhanced UE position or position-related information to a requesting application or service (e.g., associated with the UE or a lawful external entity) during a positioning session. In one aspect, the LMF 135 provides positioning assistance data to the UE 110 including, for example, information regarding signals to be measured (e.g., expected signal timing, signal coding, signal frequencies, and so on), locations and identities of terrestrial transmitters (e.g., base stations 120) and/or signal timing or orbital information for Global Navigation Satellite System (GNSS) satellites (not shown). This positioning information may be used to facilitate positioning techniques such as Assisted GNSS (A-GNSS), Advanced Forward Link Trilateration (AFLT), Observed Time Difference of Arrival (OTDOA), Enhanced Cell Identity (ECID), and so on.

To support artificial intelligence/machine learning (AI/ML) model-enhanced positioning, the CN also includes an AI/M management function (AI/ML-MF) 140 which is implemented on a server(s) or other “smart entity” associated with the CN. In the illustrated example, the AI/ML-MF is implemented as part of the functions performed by the LMF 135. However, in other examples, the AI/ML-MF 140 is implemented as a separate or independent function, within the CN, with respect to the LMF 135. The AI/ML-MF 140 maintains and deploys positioning-related AI/ML-MF models within the network as described in more detail below. The term AI/ML-MF 140 is a notation used herein to describe a core network side function that manages AI/ML model related aspects. The AI/ML-MF 140 may be any core network side function that performs the functions attributed to the AI/ML-MF herein.

For the AI-assisted positioning messages disclosed herein, the AI/ML-MF 140 and the base stations 120 may communicate using a New Radio Positioning Protocol A (NRPPa) with NRPPa messages being transferred between the base stations 120 and the AI/ML-MF 140 via the AMF 130. The AI/ML-MF 140 and the UE 110 may communicate using the LTE Positioning Protocol (LPP) where LPP messages are transferred through Non-Access Stratum (NAS) messages between the UE 110 and the AI/ML-MF 140 via the AMF 130 and a serving base station 120A for the UE. The AI/ML-MF 140 and the base stations 120 and the UE 110 may communicate using one or more dedicated AI/MF protocols with messages being transferred between the base stations 120, the UE 110, and the AI/ML-MF 140 via the AMF 130.

The wireless communication system 100 may include a Positioning Reference Unit (PRU) 115. In some aspects, a PRU at a known location (also referred to as “ground truth” location or position) can act as a measurement entity and perform measurements of position-related reference signals (e.g., positioning reference signals (PRS) from a base station) and report these measurements for use in training or monitoring the AI/ML-MF model. In addition the PRU can act as a reference signal entity and transmit sounding reference signals (SRS) to enable base stations to measure and report uplink (UL) positioning measurements for the PRU (at its known location) for use in training or monitoring the AI/ML model. From the perspective of the AI/ML-MF, the PRU functionality is realized by a UE (either stationary or mobile) with a known location. The ground truth location for a PRU may be programmed and stored in the PRU and/or provided to the AI/ML-MF at installation (for a stationary PRU) or determined during a positioning session that uses a method that does not include use of the AI/ML-MF model-enhanced techniques disclosed herein.

Positioning techniques (e.g., as provided by the LMF) may be enhanced by the addition of an AI/ML model. During a positioning session, an inference function may use the AI/ML model to generate an inferred position or inferred position-related data (referred to as “assistance data” herein) for a UE based on measurements provided by the UE. Use of AI/ML model based positioning techniques may be of particular benefit in scenarios where a UE may often be in a non-line-of-sight (NLOS) position with respect to transmission reception points (TRPs) or base stations that transmit positioning reference signals. For example, an AI/ML model may be maintained for a particular building or factory in which cellular signals are attenuated and obstacles may move.

The AI/ML model may be stored in and/or monitored by any network device, including the UE 110, a base station 120 (or other access node), or a device or server associated with the AI/ML-MF 140 or the CN more generally. Disclosed herein are various techniques for collecting measurement data and monitoring of the performance of the AI/ML model. In this disclosure, many functions and signaling are described as being performed by various entities. It is to be understood that an entity may be implemented in any of the disclosed network devices (e.g., AI/ML server, base station, UE, or PRU)

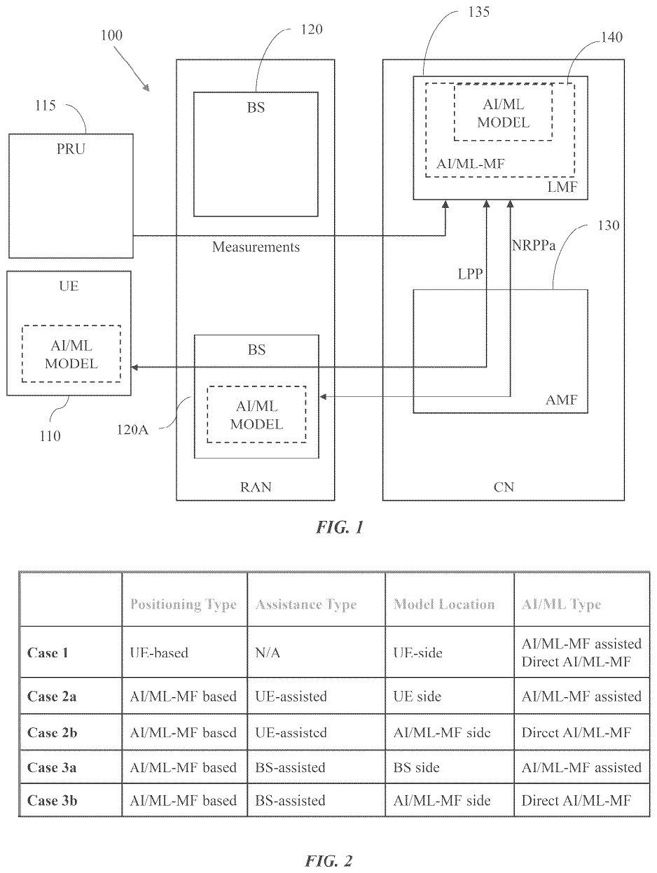

FIG. 2 is a table that outlines several possible configurations for AI/ML enhanced positioning. AI/ML-MF-based positioning and UE-based positioning will be discussed respectively. For the purposes of this disclosure, the suffix “-based” refers to the device or node (e.g., UE, base station, or AI/ML-MF (instantiated on a CN related device)) that is responsible for making the positioning calculation. The suffix “-assisted” refers to the device or node that provides measurements to another device or node that makes the positioning calculation. Thus, an operation in which measurements are provided by the UE to the AI/ML-MF to be used by the AI/ML-MF in the computation of the UE's position is described as UE-assisted and AI/ML-MF-based, while if the UE computes its own position the operation is described as UE-based.

In cases 1a and 1b, the AI/ML model is stored in memory of the UE 110 (Model Location=UE-side) and the UE calculates its own position (Positioning Type=UE-based). In case 1a, the AI/ML model output (e.g., inferred position) is used as the UE's position (AI/ML Type=Direct AI/ML). In case 1b, the AI/ML model output (e.g., inferred position or other inferred position-related information) is one input used by the UE to determine its position (AI/ML Type=AI/ML assisted).

In cases 2a, 2b, 3a, and 3b, the AI/ML-MF calculates the UE's position (Positioning Type=AI/ML-MF Based). In cases 2a and 2b, the UE provides measurement data to the AI/ML-MF (Assistance Type=UE-assisted). In case 2a, the AI/ML model is stored on the UE and the AI/ML model output (e.g., inferred position or other inferred position-related information) is one input used by the AI/ML-MF to determine the UE's position (AI/ML Type=AI/ML assisted). In case 2b, the AI/ML model is stored in memory of a network device associated with the LMF or AI/ML-MF (e.g., CN server memory) and the AI/ML model output is used as the UE's position (AI/ML Type=Direct AI/ML). It is noted that the table of FIG. 2 does not include all the types of use cases, including UE-based positioning with the AI.ML model located at the AI/ML-MF side.

In cases 3a and 3b, the BS provides measurement data to the AI/ML-MF (Assistance Type=BS-assisted). In case 3a, the AI/ML model is stored on the BS and the AI/ML model output (e.g., inferred position or other inferred position-related information) is one input used by the AI/ML-MF to determine the UE's position (AI/ML Type=AI/ML assisted). In case 3b, the AI/ML model is stored in memory of a network device associated with the LMF or AI/ML-MF (e.g., CN server memory) and the AI/MVL model output is used as the UE's position (AI/ML Type=Direct AI/ML).

### Neural Network Overview

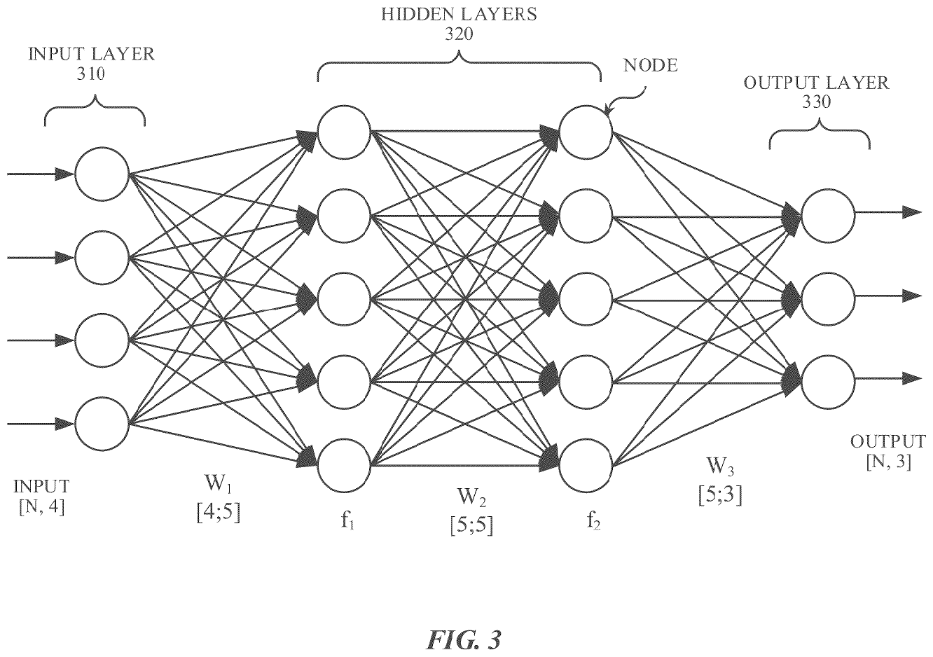

The position-related inference function performed by the AI/ML model is performed by a neural network. FIG. 3 is a diagram of an example of a neural network (NN) 300 according to one or more implementations described herein. As shown, NN 300 may include nodes arranged in different layers, such as an input layer 310 of nodes, multiple hidden or intermediary layers 320 of nodes, and an output layer 330 of nodes. In some implementations, NN 300 may be an example of, or a portion of, an AI/ML model deployed (e.g., stored) on a model entity. For example, NN 300 may be trained by a training function using training data received from a data collection entity. The NN 300 may be deployed by model configuration entity. The NN 300 may be used by an inference function that inputs inference input data (e.g., measurement data) to the input layer 310 and receives inference output data from the output layer 330. The inference function may generate an inferred position or inferred position-related information from the inference output data.

Example NN 300 may include a number N of inputs introduced to four input nodes [N, 4] of input layer 310. This may include processing or encoding input data into a form, shape, vector, or data structure, that is receivable by the NN. The four input nodes may process the inputs to produce a first weight (W₁) that the four input nodes provide to the five nodes [4;5] of a first hidden layer. The five nodes of the first hidden layer may use a first function (f₁) to process the inputs to produce a second weight (W₂) that the five nodes of the first hidden layer may provide to the five nodes [5;5] of a second hidden layer. The five nodes of the second layer may use a second function (f₂) to process the inputs to produce a third weight (W₃) that the five nodes of the second hidden layer may provide to the three nodes [5;3] of output layer 330. The nodes of output layer 330 may each process the inputs received and produce an output. This may include converting or decoding output data from a form, shape, vector, or data structure, that may be used by a subsequent algorithm, process, or procedure.

NNs, or artificial NNs (ANNs), may comprise logically interconnected nodes arranged in node layers. There may be an input layer, one or more hidden or intermediate layers, and an output layer. Each node, or artificial neuron, may connect to another and has an associated weight and threshold. If the output of any individual node is above the specified threshold value, that node is activated, sending data to the next layer of the network. Otherwise, no data may be passed along to the next layer of the network by that node. The “deep” in deep learning is just referring to the number of layers in a NN. A NN that consists of more than three layers—which would be inclusive of the input and the output—can be considered a deep learning algorithm or a deep NN. A neural network that only has three layers is just a basic NN.

### AI/ML Model System Overview

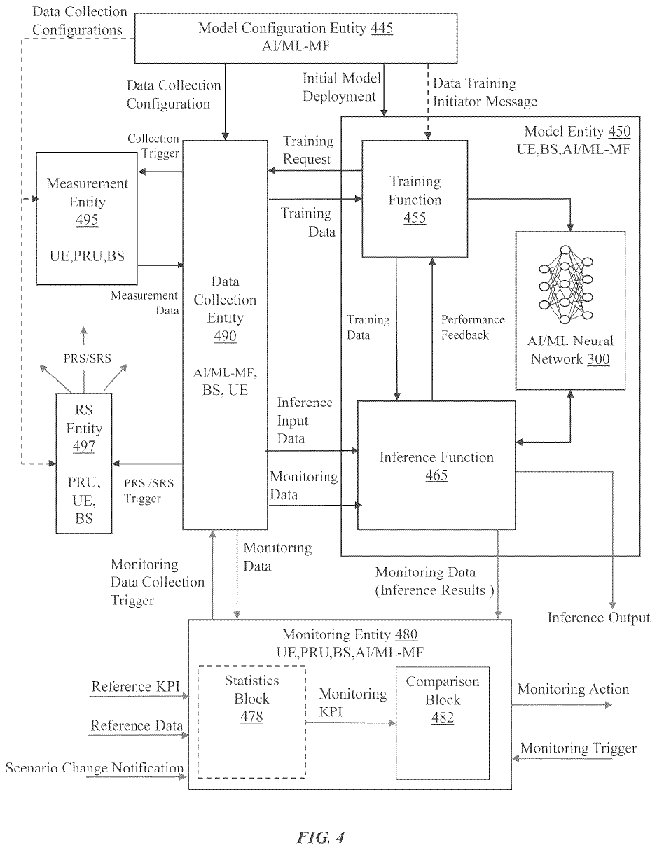

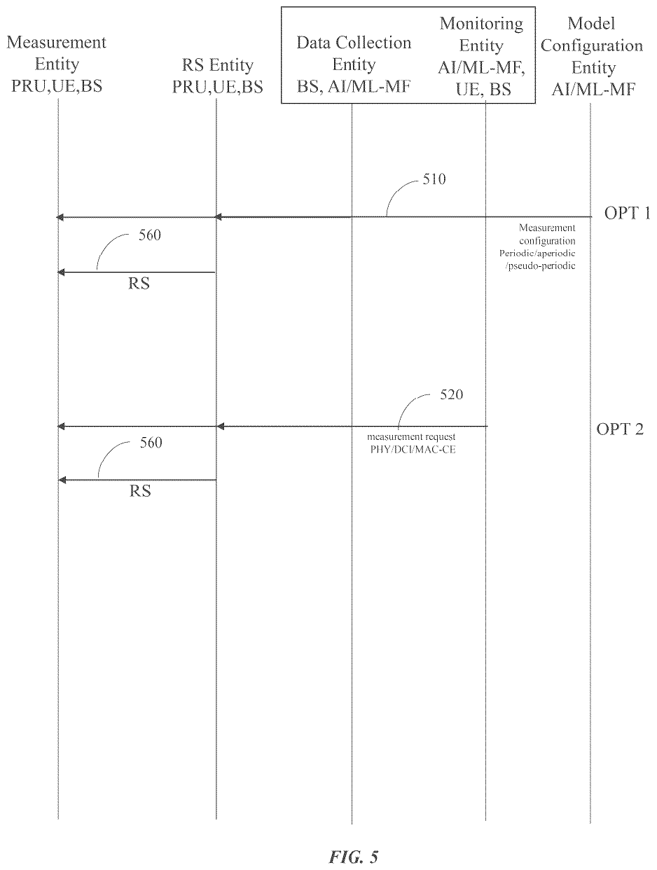

FIG. 4 is a functional block diagram of an AI/ML model system that trains and monitors an AI/ML model that can be used to generate a position-related inference output based, at least in part, on measurements made by a UE. The inference output may be an inferred position of a UE or other inferred position-related data. The system includes a model configuration entity 445, a model entity 450, a monitoring entity 480, and a data collection entity 490. An entity is a network device that performs a given function. Thus, the model configuration entity 445 is a network device that performs a model configuration function, and so on. Generally speaking each entity may include a processor, memory, and stored instructions that cause the processor to control the entity (i.e., the network device) to perform the functions associated with the entity. An entity may be, for example, a UE, a PRU, a base station, or a network device associated with the AI/ML-MF (e.g., a server).

In the illustrated example, a device associated with the AI/ML-MF serves as the model configuration entity 445. The data collection entity 490 may be a base station (e.g., base station 120 of FIG. 1), a network device associated with an AI/ML-MF (e.g., AI/ML-MF 140 of FIG. 1), a UE (e.g., UE 110 of FIG. 1). The model entity 450 may be a UE (e.g., UE 110 of FIG. 1), a base station (e.g., base station 120 of FIG. 1), or a network device associated with the AI/ML-MF (e.g., AI/ML-MF 140 of FIG. 1). The monitoring entity 480 may be a UE (e.g., UE 110 of FIG. 1), a PRU, a base station (e.g., base station 120 of FIG. 1), or a network device associated with the AI/ML-MF (e.g., AI/ML-MF 140 of FIG. 1). The monitoring entity 480 and the data collection entity 490 may be implemented on the same device (e.g., a UE with a UE-side model). The model entity 450 and the monitoring entity 480 may be implemented on different devices.

### Model Entity

The model entity 450 stores a NN 300 that, during a positioning session, generates an inference output based, at least in part, on measurement data from a UE whose position is being determined. In one example, at least some of the input data to the input nodes of NN is measurement data. In addition to measurement data, neural network inputs may also include data from other measurement entities as well as other sources, such as clock/calendar services, temperature/weather related sensors, and so on. The inference output is provided by the output nodes of the NN.

While the AI/ML model is described as a NN 300, any other type of AI/ML model may be used to generate the inference results and inference output.

The model entity 450 implements a training function 455 and an inference function 465, which may be different from one another. For the purposes of this disclosure, when a particular entity (e.g., a US, a base station, or an AI/ML-MF) is described as storing the AI/ML model, or acting as the model entity 450, it is to be understood that this entity stores the AI/ML neural network 300 and also includes hardware and stored instructions used to execute the training function 455 and the inference function 465.

The training function 455 updates the weights applied by respective nodes in the neural network 300. This training process is performed based on training data that includes measurement values which serve as neural network inputs and, usually, an associated “ground truth”. The ground truth is a known value (e.g., known based on another positioning method with a desired accuracy) which, if the AI/ML neural network 300 perfectly represented reality, would be equal to the inference output. For example, if the inference output is the location of a UE, then the training data would include respective sets of measurements made by the various measurement entities 495 and a respective ground truth for the measurement entities comprising a known location of the measurement entities (e.g., preprogrammed or determined by some other method). In some training scenarios, the ground truth may be unknown or may be intentionally distorted to simulate a noisy environment. Training data may also include data from other (non-measurement entity) sources, such as clock/calendar services, temperature/weather related sensors, and so on.

During a positioning session, the inference function 465 inputs inference data (e.g., including a UE's measurement data and possibly other assistance data not based on measurements) to the AI/ML neural network 300 and generates the inference output based, at least in part, on an output of the AI/ML neural network 300. The inference output may be used as the UE's position, may be an input to the determination of the UE's position, and may include position-related information including whether the UE is LOS or NLOS with respect to a fixed point.

In some examples, the training function 455 receives a data training initiator message from the model configuration entity 445 to initiate training. In other examples, the training function 455 initiates training based on the occurrence of some predefined event (e.g., an initial deployment of an AI/ML model in a model entity) or a training trigger generated by another device or function (e.g., a monitoring action taken by the monitoring entity 480). To train the AI/ML neural network 300 the training function 455 transmits a model training request to the data collection entity 490 and, in response, receives training data. During training, the training function 455 provides the training data to the inference function 465 and receives performance feedback (e.g., the inference output that is generated by the AI/ML neural network 300 in response to the training data). Based on the performance feedback, the training function 455 adapts the neural network by adding or subtracting nodes, modifying inputs summed by virtual nodes, adapting weights applied by the virtual nodes, and so on.

### Measurement Entity

The AI/ML model system relies on data from measurement entities 495 for providing positioning services and training and monitoring of the AI/ML NN 300. Measurement entities include PRUs or base stations or, in some examples, UEs that have a secondary means for sufficiently accurately determining their ground truth location without relying on an inference output. Measurement entities may be static or mobile. The measurement entities provide an indication of their AI/ML model capability to the model configuration entity 445, including information about the accuracy of the measurement entity's ground truth value and which types of measurements the measurement entity can make. When an AI/ML model is deployed to the model entity 450, capable measurement entities are configured to perform measurements to generate the types of measurement data that is collected to train and monitor the AI/ML NN 300. The configuration of the measurement entities for use in collecting data for an AI/ML model may be performed by a data collection entity 490 (which may be implemented in a same device as the monitoring entity 480 and model entity 450) or the model configuration entity 445.

Example measurement data includes channel impulse response (CIR), Power Delay Profile (PDP), time of arrival (TOA), angle of arrival (AOA), and so on. The measurement entity may also provide measurement data that is the result of additional logical functions by the measurement entity, such as measurement data that indicates whether the measurement entity is LOS or NLOS with respect to the RS entity 497. The measurement entities may measure signals from base stations, UEs, or PRUs. For example, a UE measurement entity may measure sidelink positioning reference signals from another UE or downlink positioning reference signals from a base station while a base station measurement entity may measure SRS from UEs or PRUs.

The measurement entities may be configured to make measurements periodically or semi-persistently or in response to a trigger from the data collection entity 490. The measurement entities may be configured to measure the RS and provide measurement data when the network device is providing other position-related feedback to an AI/ML-MF server or when the measurement entity arrives at a preconfigured location.

### RS Entity

The RS entity 497 transmits reference signals that are measured by measurement entities 495 to generate the measurement data collected by the data collection entity. RS entities include base stations and PRUs/UEs. A base station acting as an RS entity transmits position related reference signals (PRS), which include, for example, DL-PRS. A UE or PRU acting as an RS entity transmits sounding reference signals (SRS) which may be received by measurement entities including another UE or PRU or a base station or sidelink position related reference signals (SL-PRS) which may be received by measurement entities including another UE or PRU.

The configuration of the RS entities for use in collecting data for an AI/ML model may be performed by the data collection entity 490 or the model configuration entity 445. RS parameters that may be configured include bandwidth, time duration, and so on). The RS entity is configured with a trigger which, when received, will cause the RS entity to transmit the RS. The trigger may be provided in a physical layer signal, a media access control signal, or a higher layer signal. Different RS may be configured for use in AI/ML model training as compared to monitoring. Alternatively, the RS entity may be configured to transmit the RS on a periodic or semi-persistent basis.

### Model Configuration Entity

The model configuration entity 445 may store multiple models (e.g., for different locations, conditions, and so on) and perform an initial deployment of one or more models to the model entity 450. The models may have an initially trained condition and a monitoring process or training process may be performed upon deployment. The model configuration entity may control selection of which model is deployed to the model entity 450.

In one example, the model configuration entity 445 configures the measurement entities 495 and RS entities 497 based on a model being deployed. In another example, the data collection entity 490 receives the data collection configurations from the model configuration entity 445 and passes a measurement configuration to the measurement entities 495 and an RS configuration to RS entities 497. During the configuration process, the model configuration entity 445 may identify the model that is associated with the measurements and a required quality (e.g., accuracy) of the measurements. The configuration process may also define labels to be attached to each measurement.

As will be disclosed in more detail in FIGS. 5-10, the measurement configuration provides information identifying specific position-related measurements the measurement entity is to perform in response to requests for training data and requests for monitoring data. While training data may be a fairly comprehensive set of measurements from many or all measurement entities, the monitoring data may be a subset of training data selected as being sufficiently representative of the complete set of training measurements. The monitoring data may include fewer measurement types and/or measurements from fewer measurement entities or possibly predetermined data (e.g., “artificial” data) that simulates measurement data but is not the result of measurements made a measurement entity. The monitoring data may include inference output performed based on monitoring measurement data.

The RS configuration configures RS entities 497 (e.g., UEs, PRUs or base stations) to transmit specific positioning-related reference signals (RS). The model configuration entity 445 may configure different measurements and RS for use in generating training data versus monitoring data that is used for monitoring.

### Monitoring Entity and Data Collection Entity

In some examples, the monitoring entity 480 and the data collection entity 490 are implemented in a same network device. The functions of these two entities are described separately in some instances for clarity. In some examples the same network device also implements the model entity 450. In some examples the monitoring, data collection, and model entities are implemented by a UE. To maintain the quality of the inference output, in response to a received monitoring trigger or a monitoring condition being met, the monitoring entity 480 performs a monitoring process that checks the accuracy of inference results generated by the AI/ML model. Based on the results, may trigger a monitoring action such as retraining the AI/ML model.

The monitoring process may be performed periodically (e.g., at the expiration of a timer which is configured statically or semi-persistently) or aperiodically. The monitoring process may be triggered in any number of ways. The monitoring process may be triggered by the model entity when inference data falls outside a historical range. The monitoring trigger may be generated by an external entity or internally by the monitoring entity based on a combination of internal and/or external events, such as a change in the operating conditions or scenario of the UE which might likely degrade the AI/ML model performance. An entity that performs a monitoring action (e.g., the model entity 450) may, after performing the monitoring action (e.g., training the model), provide a monitoring trigger to the monitoring entity.

The monitoring entity 480 may receive one or more scenario change notification signals that indicate a change in operating scenario that may affect the performance of the AI/ML model system. The scenario change notification signals may indicate a time at which a change occurs and may also indicate the type of change, such as, for example, a change in physical location of the system entities (e.g., measurement entities, RS entities, and so on), system entities being taken offline, changes in media or channel conditions due to significant interference events, and so on. For example, when a PRU is moved, the positioning AI/ML model for the PRU will be changed. Thus, when a sufficient number of PRUs have experienced a model change, the model configuration entity 445 may provide a scenario change notification signal to the monitoring entity that includes a timing of the scenario change. In another example, when a line of sight (LOS)/non-line-of-sight (NLSO) probability as between different entities in the model system changes, this may indicated movement of one or more system entities. When sufficient LOS/NLOS probability changes are detected, an external entity that tracks these probabilities may generate a scenario change notification signal. The monitoring entity 480 may use the scenario change notification signal to trigger the monitoring process. As will be disclosed in more detail below, the scenario change notification signal may also be used during the generation of statistics for determining a monitoring KPI.

The monitoring entity 480 includes a statistics block 478 and a comparison block 482. In some examples, the statistics block 478 may be implemented on a different network device than the comparison block 482. For example, a network device with significant processing power may host the statistics block 478. To accomplish the monitoring function, the monitoring entity 480 receives monitoring data and a reference key performance indicator (KPI) value (e.g., a ground truth value or other known or historical position-related information). In one example, the reference KPI is ground truth position of the measurement entity, a position of the measurement entity determined by a non-model based technique, or a Global Navigation Satellite System (GNSS) estimate of the position of the measurement entity. The monitoring KPI may include an intermediate output of the AI/ML model. The monitoring data may be measurement data or inference result data.

### Measurement Data for Monitoring

FIG. 5 is a message flow diagram outlining two example techniques for causing transmission of reference signals for use in generating measurement data for monitoring purposes. In a first option, the RS entity (or entities) and the measurement entity (or entities) receive a measurement configuration 510. In the illustrated example, the measurement configuration is transmitted by the model configuration entity. In other examples, the measurement configuration is transmitted by the monitoring entity. The measurement configuration 510 may be transmitted using higher layer signaling and may cause, configure, or trigger periodic, semi-periodic, or aperiodic transmission (e.g., by the RS entity) and measurement of configured RS signals 560 (e.g., by the measurement entity). The measurement configuration 510 may cause, configure, or trigger the RS entity to transmit RS signals 560 a single time or in bursts in which a sequence of RS are transmitted with a configured gap between. The sequence of RS may have a configurable length. The measurement configuration 510 may configure triggerable RS signals that are triggered by a subsequent signal (higher layer or physical (PHY) layer) from the model configuration entity or monitoring entity.

The measurement configuration 510 may cause the measurement entity to measure the RS 560 and provide the measurement data when the measurement entity is providing other position-related feedback to the network device. The measurement configuration may cause or configure the measurement entity to measure the RS and provide measurement data when the measurement entity arrives at a preconfigured location.

In a second option, the monitoring entity may request or trigger RS signals 560 and measurement by measurement entities to generate monitoring data via a PHY layer message 520. The PHY layer message may be transmitted on a periodic, aperiodic, or semi-persistent basis. The PHY layer message may request reference signals configured on a periodic, aperiodic, or semi-persistent basis. The PHY layer message 520 may include, for example, downlink control information (DCI) or a media access control (MAC) control element (CE). The PHY layer message 520 may cause RS signals 560 to be transmitted a single time or in bursts in which a sequence of RS are transmitted with a configured gap between.

The monitoring of the AI/ML model may be based on a comparison between current input data for the AI/ML model (e.g., measurement data) and training or other reference data. The monitoring of the AI/ML model may be based on a comparison between current AI/ML model output data and model output data that was generated previously in response to training or other reference data. The monitoring of the AI/ML model may be based on a comparison between current AI/ML model output data and a ground truth value.

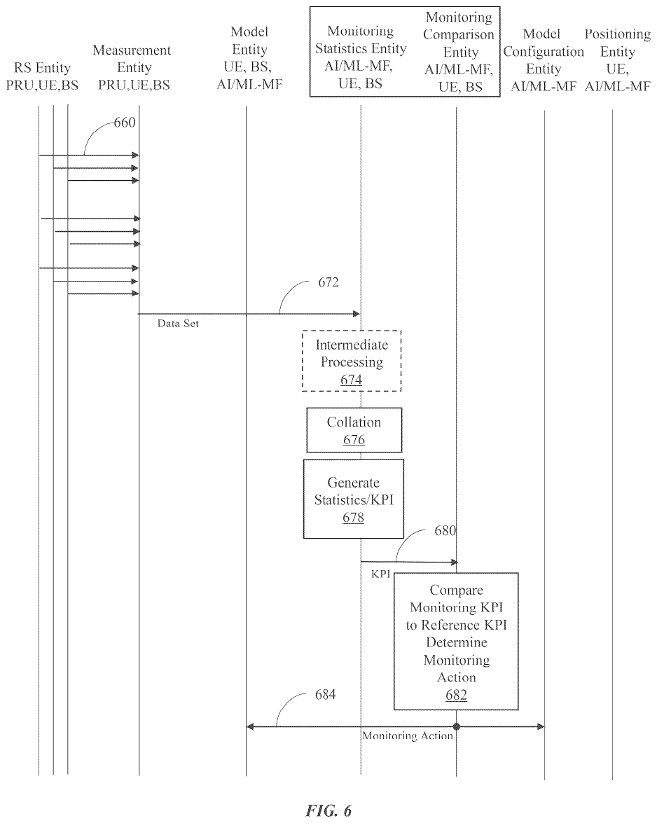

FIGS. 6-10 illustrate example processes for monitoring an AI/ML model as adapted for the use cases of FIG. 2. Functions performed by the statistics block 478 and comparison entity 482 of FIG. 4 are included in each of the processes of FIGS. 6-10. A description of some the common functions performed by the statistics and monitoring comparison block will now be disclosed before providing details about the separate processes of FIGS. 6-10.

### Intermediate Processing

The statistics block may perform intermediate processing (see 674, 774, 874, 974, 1074 of FIGS. 6-10, respectively) on a received data set (see 672, 772, 872, 972, 1072 of FIGS. 6-10, respectively). As will be disclosed in more detail below, the data set may be monitoring data such as “raw” measurement data generated by measurement entities or the output of the AI/ML model (e.g., inference results), or a comparison result between monitoring data and a value derived based on a ground truth value. All of these different types of data which may be input to the statistics block are referred to as AI/ML data herein. The AI/ML data used for monitoring purposes may correspond to data also used for positioning services. In other words, recent data used for normal operation of the positioning system may be logged and used for monitoring purposes.

Intermediate processing may include filtering the data set to remove selected values or select data meeting a certain criteria. Intermediate processing may include grouping the data set based on some criteria and deriving a statistical quantity from the groups of data (e.g., an average, a distribution, and so on). The criteria used in grouping may include a reference signal associated with the data, a measurement device associated with the data, a transmission time or range of transmission times for reference signals associated with the data. Intermediate processing may include accumulating data from multiple data sets and, when a threshold or trigger condition is met, passing the accumulated data to a collation function or performing subsequent intermediate processing on the accumulated data.

The intermediate processing may include considering any scenario change notification signals that are received by the monitoring entity. When grouping measurement data and/or performing statistical analysis, the intermediate processing block will not group measurement data that spans a scenario change timing and/or make comparisons between measurement data occurring before and after the scenario change.

Another example of intermediate processing is providing the received measurement data to a monitoring model that performs inference on the measurement data to generate monitoring inference data used in generating statistics.

### Collation

The statistics block performs a collation function (see 676, 776, 876, 976, 1076 of FIGS. 6-10, respectively) on the data set (when intermediate processing is not performed) or the output of the intermediate processing. The collation function may perform operations such as filtering or culling data, conditioning data, ordering data according to a timing or type reference signal with which it is associated or grouping data into batches to facilitate statistical analysis.

### Statistics/KPI Generation

The statistics block generates statistics based on the collated data to generate a monitoring KPI. The statistics may be based on a single measurement metric such as, for example, a delay spread, Doppler shift, reference signal received power (RSRP), or signal to interference and noise ratio (SINR). The statistics may be based on monitoring data generated based on several references signals over a period of time. The statistical analysis is used to generate a monitoring KPI. The monitoring KPI may be any one of a number of quantities. For example, the monitoring KPI may be an average value of a set of measurement data, inference results, or positions determined based on the monitoring data. The monitoring KPI may be a statistical quantity such as a distribution of the monitoring data (e.g., a three sigma range), an average difference between an instance of the monitoring data and a corresponding instance of reference data (e.g. training data or ground truth value). The monitoring KPI may be based on an inference output of a monitoring model that is indicative of how much measurement data has changed to require a monitoring action.

### KPI Comparison

The monitoring comparison entity receives the monitoring KPI and compares it to a reference KPI (see 682, 782, 882, 982, 1082 of FIGS. 6-10, respectively). The reference KPI may be a ground truth value or other value derived from one or more ground truth values. The reference KPI may be a statistical quantity derived based on training data or other reference (e.g., historical or artificial) data. The monitoring comparison entity may receive the reference KPI from another entity (e.g., a positioning entity that determines the UE position based on a method that does not rely on the AI/ML model) or derive the reference KPI based on training data or other reference data. The monitoring comparison entity may store reference KPIs for use in monitoring respective different AI/ML models. The reference KPIs may be provided to the monitoring entity by way of higher layer signaling, L1 signaling and on a periodic, aperiodic, or semi-persistent basis.

Based on the comparison, the monitoring comparison entity performs a monitoring action. For example, if the monitoring KPI and the reference KPI meet an equivalence criteria (e.g., have values that fall within a range of one another), the monitoring comparison entity may record the equivalence or signal to another entity an indication that the AI/ML model is operating satisfactorily. If the KPIs do not meet the equivalence criteria, the monitoring entity may signal the model entity to train the model or to cease generating inference results. The monitoring action may include causing the model configuration entity to deploy a different AI/ML model to the model entity, de-activate inference-based positioning, fine-tune the AI/ML model, fully train the AI/ML model, or provide a signal to a decision entity that determines a course of action.

FIGS. 6-10 illustrate message flow diagrams that outline the exchange of information between the various entities described above. In some examples, entities depicted as exchanging messages or data are implemented in the same network device (e.g., a UE). In those examples it is to be understood that the exchange of information communicated in the illustrated messages occurs internally to the network device and are not communicated via wireless communication messages transmitted and received over the wireless network. When the entities exchanging information are implemented in different network devices, the illustrated messages, data, and so on are transmitted and received over the network via wireless or wired communication channels.

### Monitoring Based on Measurement Input

FIG. 6 is a message flow diagram outlining an example flow of signaling and messages that occur during AI/ML monitoring based on measurement input. The signaling and messages illustrated in FIG. 6 apply to all use cases of FIG. 2 without substantial modification. In other words, regardless of which entity serves as the model entity and whether the positioning performed is AI/ML direct or AI/ML indirect, the general process outlined in FIG. 6 may be used to perform monitoring based measurement inputs. Measurement input based monitoring may be performed to determine if the inputs that are being used to generate the inference result have changed significantly since the AI/ML model was trained, which may be one indication that the AI/ML model may not be providing accurate results.

Reference signals 660 are transmitted to one or more measurement entities to generate measurement data. A data set 672 comprising the measurement data is provided to a monitoring statistics entity that implements the statistics block (e.g., 478 of FIG. 4). The monitoring statistics entity performs intermediate processing 674 (optionally), collation 676, and statistical analysis to generate the monitoring KPI 678. The monitoring KPI 680 is provided to the monitoring comparison entity and at 682 the monitoring comparison entity compares the monitoring KPI to a reference KPI. The reference KPI may be derived based on training data for the model or another reference data set.

For monitoring based on measurement input, the KPI may be an average of any measurement data (e.g., RSRP, SINR, TOA, and so on) or a statistical distribution (e.g., cumulative distribution function (CDF)) of measurement data over a certain time period. Based on the comparison at 682, the monitoring comparison entity takes a monitoring action 684 as disclosed above. The monitoring KPI may also be at least partially based on non-measurement data quantities such as environmental factors (e.g., whether the UE is indoors or outdoors).

In model monitoring using measurement input without ground truth, the monitoring metric may be statistics of measurement data as compared to statistics of the training data. The measurement data used in monitoring may not be the same as the measurement data input to the AI/ML model. If the measurement data used in monitoring is not the same as the measurement data input to the AI/ML model, a bursty trigger should be used. Note that the statistics block may be implemented in a separate entity from the monitoring comparison entity

### Monitoring Based on Model Output Statistics (No Ground Truth)

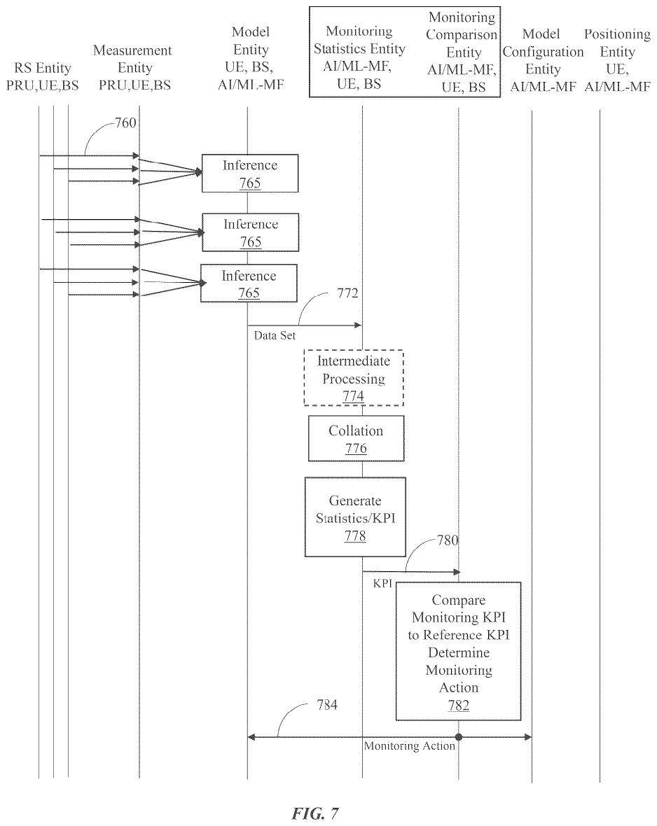

FIG. 7 is a message flow diagram outlining an example flow of signaling and messages that occur during AI/ML monitoring based on AI/ML model output without reliance on a ground truth value. The signaling and messages illustrated in FIG. 7 apply to all use cases of FIG. 2 without substantial modification. In other words, regardless of which entity serves as the model entity and whether the positioning performed is AI/ML direct or AI/ML indirect, the general process outlined in FIG. 7 may be used to perform monitoring based on model output statistics. Model output statistics based monitoring may be performed to determine if the output of the AI/ML model has changed significantly since the AI/Ml model was trained, which may be one indication that the AI/ML model may not be providing accurate results.

Reference signals 760 are transmitted to one or more measurement entities to generate measurement data. The measurement data is provided to the model entity and at 765 the AI/ML model performs inference based on the measurement data. A data set 772 comprising the inference results is provided to the monitoring statistics entity that implements the statistics block (e.g., 478 of FIG. 4). The monitoring statistics entity performs intermediate processing 774 (optionally), collation 776, and statistical analysis to generate the monitoring KPI 778. The monitoring KPI 780 is provided to the monitoring comparison entity and at 782 the monitoring comparison entity compares the monitoring KPI to a reference KPI. The reference KPI may be derived based on training data for the model or another reference data set.

For monitoring based on model output statistics, the monitoring KPI may be an average of any inferred assistance data (e.g., RSRP, SINR, TOA, and so on) or inferred position, a statistical distribution (e.g., CDP) of the inferred assistance data or inferred position over a certain time period, and so on. Based on the comparison at 782, the monitoring comparison entity takes a monitoring action 884 as disclosed above.

Monitoring Based on Model Output with Ground Truth

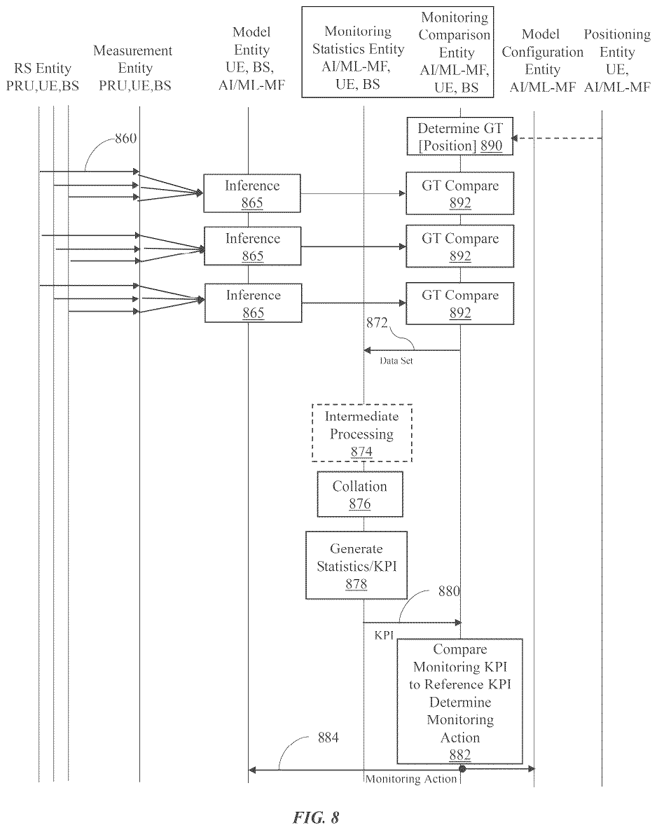

FIG. 8 is a message flow diagram outlining an example flow of signaling and messages that occur during AI/ML monitoring based on AI/ML model output as compared to a ground truth value. The signaling and messages illustrated in FIG. 8 apply to use cases 1, 2b, and 3b of FIG. 2, in which the output of the AI/ML model is position, without substantial modification. In other words, regardless of which entity serves as the model entity and when the positioning performed is AI/ML direct, the general process outlined in FIG. 8 may be used to perform monitoring based on model output and a ground truth value. This type of monitoring may be used to more directly determine a performance of the AI/ML model as compared to using measurement input or model output statistics.

Reference signals 860 are transmitted to one or more measurement entities to generate measurement data. The measurement data is provided to the model entity and at 865 the AI/ML model performs inference based on the measurement data to determine an inferred position. At 890 the monitoring comparison entity determines a ground truth (GT) position for the UE. The ground truth position may be received from a positioning entity, which is capable of determining the position of the UE using other means, such as a global navigation satellite system (GNSS). The monitoring comparison entity may receive the ground truth position from another entity in other examples or may store the ground truth position for use in monitoring when certain criteria are met (e.g., the UE moves to a known location based on some sensor input). The ground truth position may be determined using a traditional radio access technology (RAT)-based positioning method.

At 892, the inference outputs are compared to the ground truth. A data set 872 comprising the comparison results (e.g., a deviation or difference between the inferred position and the ground truth position) is provided to the monitoring statistics entity that implements the statistics block (e.g., 478 of FIG. 4). The monitoring statistics entity performs intermediate processing 874 (optionally), collation 876, and statistical analysis to generate the monitoring KPI 878. The monitoring KPI 880 is provided to the monitoring comparison entity and at 882 the monitoring comparison entity compares the monitoring KPI to a reference KPI. The reference KPI may be a predetermined acceptable deviation between the model output and the ground truth position.

In some examples, augmented input data and an associated augmented ground truth value may be generated by the monitoring entity during training. During monitoring, the monitoring entity may use the same technique to generate additional augmented data and an associated ground truth value. The augmented data may be presented to the AI/ML model to generate a ground truth value and, this inferred ground truth value is compared to the generated ground truth value.

For monitoring based on measurement input, the KPI may be an average difference, in distance, between the inferred position and the ground truth position over a certain time period, and so on. Based on the comparison at 882, the monitoring comparison entity takes a monitoring action 884 as disclosed above.

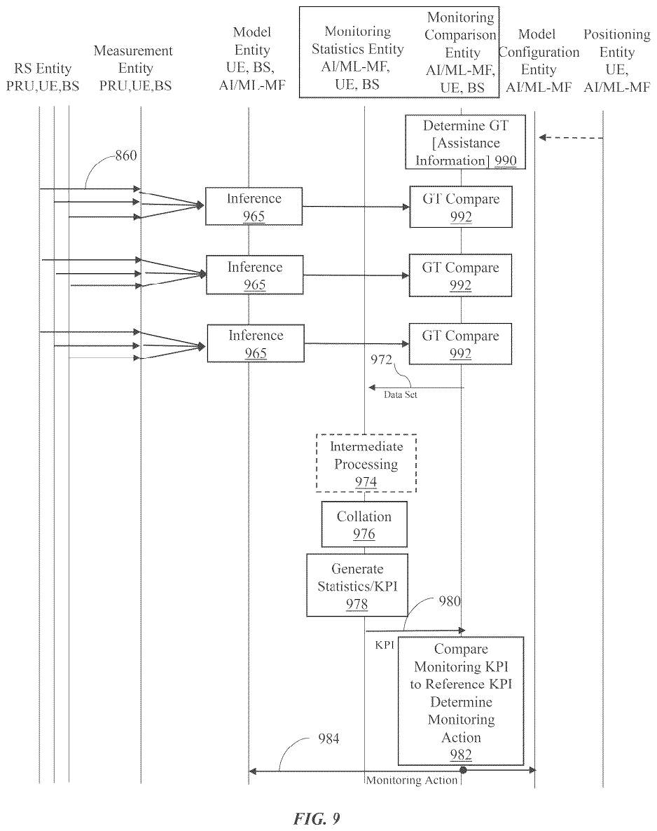

FIG. 9 is a message flow diagram outlining an example flow of signaling and messages that occur during AI/ML monitoring based on AI/ML model output as compared to a ground truth value. The signaling and messages illustrated in FIG. 9 apply to use cases 1, 2a, and 3a of FIG. 2, in which the output of the AI/ML model is assistance information, without substantial modification. In other words, regardless of which entity serves as the model entity and when the positioning performed is AI/ML-indirect, the general process outlined in FIG. 9 may be used to perform monitoring based on model output and a ground truth value. This type of monitoring may be used to more directly determine a performance of the AI/ML model as compared to using measurement input or model output statistics. In the example illustrated in FIG. 9, the ground truth value is assistance information.

Reference signals 960 are transmitted to one or more measurement entities to generate measurement data. The measurement data is provided to the model entity and at 965 the AI/ML model performs inference based on the measurement data to determine inferred assistance information. At 990 the monitoring comparison entity determines a ground truth (GT) value for the assistance information. The ground truth assistance information may be determined by the monitoring entity based on a ground truth position received from a positioning entity. The ground truth position may be based on GNSS position, traditional (non-inference based) RAT-based methods, having a known position based on sensor data, or based on synthetic data generated from inputs. The monitoring comparison entity may receive the ground truth assistance information from another entity in other examples or may store the ground truth assistance information for use in monitoring when certain criteria are met (e.g., the UE moves to a known location based on some sensor input).

At 992, the inference outputs are compared to the ground truth. A data set 972 comprising the comparison results (e.g., a deviation or difference between the inferred assistance information and the ground truth assistance information) is provided to the monitoring statistics entity that implements the statistics block (e.g., 478 of FIG. 4). The monitoring statistics entity performs intermediate processing 974 (optionally), collation 976, and statistical analysis to generate the monitoring KPI 978. The monitoring KPI 980 is provided to the monitoring comparison entity and at 982 the monitoring comparison entity compares the monitoring KPI to a reference KPI. The reference KPI may be a predetermined acceptable deviation between the model inferred assistance information and the ground truth assistance information.

For monitoring based on measurement input, the KPI may be an average difference, in distance, between the inferred assistance information and the ground truth assistance information over a certain time period, and so on. Based on the comparison at 982, the monitoring comparison entity takes a monitoring action 984 as disclosed above.

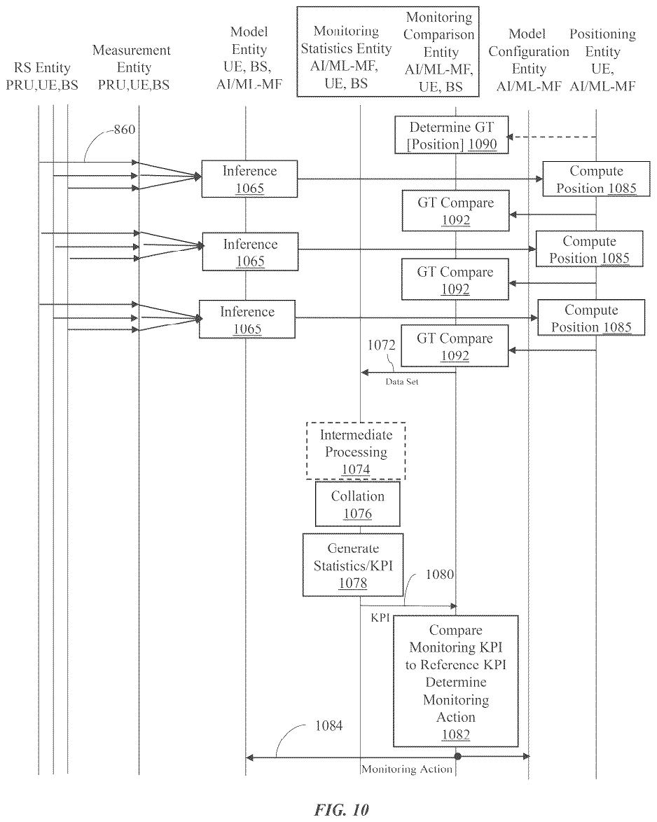

FIG. 10 is a message flow diagram outlining an example flow of signaling and messages that occur during AI/ML monitoring based on AI/ML model output as compared to a ground truth value. The signaling and messages illustrated in FIG. 10 apply to use cases 1, 2a, and 3a of FIG. 2 without substantial modification. In other words, regardless of which entity serves as the model entity and when the positioning performed is AI/ML-indirect, the process outlined in FIG. 10 may be used to perform monitoring based on model-inferred assistance information and a ground truth position. This type of monitoring may be used to more directly determine a performance of the AI/ML model as compared to using measurement input or model output statistics. In the example illustrated in FIG. 9, the ground truth value is a ground truth position.

Reference signals 1060 are transmitted to one or more measurement entities to generate measurement data. The measurement data is provided to the model entity and at 1065 the AI/ML model performs inference based on the measurement data to determine inferred assistance information. The inference results are provided to the positioning entity and, at 1085 a position is computed based on the inferred assistance information.

At 990 the monitoring comparison entity determines a ground truth (GT) position. The ground truth position may be determined by the monitoring entity based on a ground truth position received from the positioning entity. The monitoring comparison entity may receive the ground truth position from another entity in other examples or may store the ground truth position for use in monitoring when certain criteria are met (e.g., the UE moves to a known location based on some sensor input). The ground truth position may be based on GNSS position, traditional (non-inference based) RAT-based methods, having a known position based on sensor data, or based on synthetic data generated from inputs.

At 1092, the computed positions are compared to the ground truth position. A data set 1072 comprising the comparison results (e.g., a deviation or difference between the computed position and the ground truth position) is provided to the monitoring statistics entity that implements the statistics block (e.g., 478 of FIG. 4). The monitoring statistics entity performs intermediate processing 1074 (optionally), collation 1076, and statistical analysis to generate the monitoring KPI 1078. The monitoring KPI 980 is provided to the monitoring comparison entity and at 1082 the monitoring comparison entity compares the monitoring KPI to a reference KPI. The reference KPI may be a predetermined acceptable deviation between the position computed based on the model inferred assistance information and the ground truth position.

For monitoring based on measurement input, the KPI may be an average difference, in distance, between the position computed based on the model inferred assistance information and the ground truth position over a certain time period, and so on. Based on the comparison at 1082, the monitoring comparison entity takes a monitoring action 1084 as disclosed above.

The following tables summarize additional aspects of AI/ML model monitoring.

TABLE 1
MONITORING ENTITY LOCATION

| | Specification impact if blocks are separated |
|---|---|
| Case 1 | Option 1: All Monitoring at UE |
| (Direct) | Option 2: Statistics block at UE, comparison block and monitoring |
| | decision at LMF |
| | Option 3: Statistics and comparison blocks at UE and monitoring decision |
| | at LMF |
| Case 1 | Option 1: All Monitoring at UE |
| (AI-assisted) | Option 2: Statistics block at UE, comparison block and monitoring |
| | decision at LMF |
| | Option 3: Statistics and comparison blocks at UE and monitoring decision |
| | at LMF |
| Case 2a | Option 1: All Monitoring at UE |
| | Option 2: Statistics block at UE, comparison block and monitoring |
| | decision at LMF |
| | Option 3: Statistics and comparison block at UE and monitoring decision at |
| | LMF |
| Case 2b | Option 1: All Monitoring at LMF |
| Case 3a | Option 1: Monitoring at gNB |
| | Option 2: Statistics block at gNB, comparison blocks and monitoring |
| | decision at LMF |
| | Option 3: Statistics block and comparison blocks at gNB and monitoring |
| | decision at LMF |
| Case 3b | Option 1: All Monitoring at LMF |

TABLE 2
ASSISTANCE SIGNALING FROM AI/ML-MF TO UE/PRU/BS
FOR UE/BS-SIDE MODEL MONITORING

| | benefit(s)/feasibility/necessity |
|---|---|
| Case 1 | Assist UE in deciding if model is applicable e.g. scenario change, Trigger |
| (Direct) | UE monitoring. |
| | potential specification impact: Assistance information sent by LMF to UE |
| | in LPP |
| Case 1 | Assist UE in deciding if model is applicable e.g. scenario change, |
| (AI-assisted) | LOS/NLOS condition. Trigger UE monitoring. |
| | potential specification impact: Assistance information sent by LMF to UE |
| | in LPP |
| Case 2a | Assist UE in deciding if model is applicable e.g. scenario change, |
| | LOS/NLOS condition. Trigger UE monitoring. |
| | potential specification impact: Assistance information sent by LMF to UE |
| | in LPP |
| Case 2b | N/A |
| Case 3a | Assist gNB in deciding if model is applicable e.g. scenario change, |
| | LOS/NLOS condition. Trigger UE monitoring. |
| | potential specification impact: Assistance information sent by LMF to gNB |
| | in NRPPa |
| Case 3b | N/A |

TABLE 3
ASSISTANCE SIGNALING FROM UE/PRU
FOR NETWORK-SIDE MODEL MONITORING

| | benefit(s)/feasibility/necessity |
|---|---|
| Case 1 | Applicable if UE to inform LMF based on UE side monitoring/statistics |
| (Direct) | estimation |
| | Spec Impact: signaling to indicate condition reached or action taken e.g. |
| | fallback |
| Case 1 | Applicable if UE to inform LMF based on UE side monitoring/statistics |
| (AI-assisted) | estimation |
| | Spec Impact: signaling to indicate condition reached or action taken e.g. |
| | fallback |
| Case 2a | Applicable if UE to inform LMF based on UE side monitoring/statistics |
| | estimation |
| | Spec Impact: signaling to indicate condition reached or action taken e.g. |
| | fallback |
| Case 2b | Assist LMF in deciding if model is applicable e.g. scenario change, |
| | Trigger LMF monitoring. |
| | potential specification impact: Assistance information by UE/PRU to LMF |
| | in LPP |
| Case 3a | Assist LMF in deciding if model is applicable and to trigger signal from |
| | LMF to gNB e.g. scenario change, Trigger LMF monitoring. |
| | potential specification impact: Assistance information by UE/PRU to LMF |
| | in LPP, trigger from LMF to gNB via NRPPa |
| Case 3b | Assist gNB in deciding if model is applicable e.g. scenario change, |
| | Trigger LMF monitoring. |
| | potential specification impact: Assistance information by UE/PRU to LMF |
| | in LPP, |
| | potential specification impact: Assistance information by UE/PRU to LMF |
| | in LPP |

TABLE 4 summarizes aspects of model monitoring based on a provided ground truth or its approximation. The monitoring metric may be statistics of the difference between the model output and the provided ground truth label. Different use cases may include different provisioning of ground truth label and associated ground truth quality.

TABLE 4

| | potential specification impact: |
|---|---|
| Case 1 | Trigger for bursty RS to enable statistics collection. |
| (Direct) | If configured and permission is granted, LMF may provide GT information |
| | to UE |
| Case 1 | Trigger for bursty RS to enable statistics collection. |
| (AI-assisted) | If configured and permission is granted, LMF may provide GT information |
| | to UE |
| Case 2a | Trigger for bursty RS to enable statistics collection. |
| | If configured and permission is granted, LMF may provide GT information |
| | to UE |
| | Report from LMF to UE of estimated position for comparison with |
| | position GT. |
| Case 2b | Trigger for bursty RS to enable statistics collection. |
| | Report of GT information from PRU to LMF for comparison |
| Case 3a | Trigger for bursty RS to enable statistics collection. |
| Case 3b | Trigger for bursty RS to enable statistics collection. Feedback of GT to |
| | from PRU to LMF for comparison |

FIG. 11 is a flow diagram outlining an example method 1100 for causing generation of measurement data for AI/ML model monitoring purposes. The method 1100 may be performed by a monitoring entity (e.g., 480 of FIG. 4) and/or a network device acting as or implementing the monitoring entity. For example, the method 1100 may be performed by a server or server function associated with an LMF or AI/MF, a UE, or a base station.

The method includes, at 1110, causing one or more measurement entities to measure reference signals and generate measurement data for use in monitoring an AI/ML model used for AI-assisted positioning. At 1120, the method includes monitoring a performance of the AI/ML model based on the measurement data.

In some examples, the reference signals measured by the one or more measurement entities are transmitted on a preconfigured periodic, aperiodic, or pseudo-periodic basis. The method may include transmitting a configuration of the reference signals to one or more reference signal entities, wherein the configuration configures the reference signals on a periodic, aperiodic, or pseudo-periodic basis. See, for example, Option 1 in FIG. 5.

In some examples, the method includes transmitting a physical layer request for the reference signals to one or more reference signal entities. The physical layer request may be, for example, DCI, MAC-CE, or other PHY layer message.

In some examples, the measurement data is used by the AI/ML model to generate inference results. In this example, measurement data used to generate inference results for positioning services may be logged for use for monitoring purposes on an intermittent or continuous basis.

The method may include configuring the one or more measurement entities to accumulate measurement data collected in response to multiple reference signals and transmit the accumulated measurement data to the network device. In this manner the measurement data may be stored by a measurement entity (e.g., a UE) and transmitted in batches to the monitoring entity to reduce signaling overhead.

The method may include triggering one or more reference signal entities to transmit multiple reference signals and triggering the one or more measurement entities to measure the multiple reference signals.

In some example, the method includes determining whether measurement data is valid based on an indicator associated with the measurement data and subtracting invalid measurement data from the measurement data from a data set used to monitor the AI/ML model.

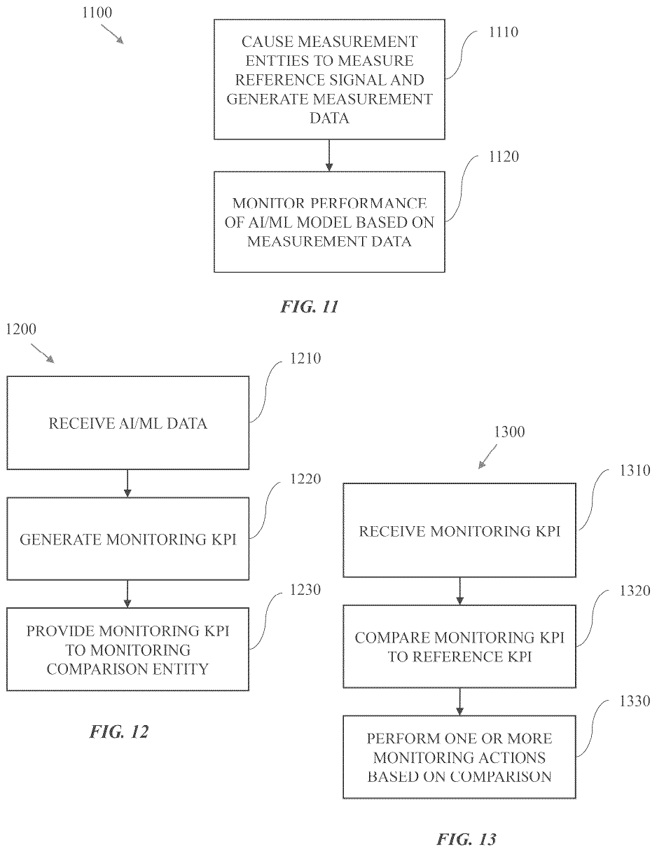

FIG. 12 is a flow diagram outlining an example method 1200 for causing generation of measurement data for AI/ML model monitoring purposes. The method 1200 may be performed by an entity implementing a monitoring statistics block (e.g., 478 of FIG. 4) and/or a network device acting as or implementing a monitoring entity (e.g., 480 of FIG. 4). For example, the method 1200 may be performed by a server or server function associated with an LMF or AI/MF, a UE, or a base station, or a distributed computing node.

The method includes, at 1210, receiving a data set comprising artificial intelligence/machine learning (AI/ML) data. Respective AI/ML data in the data set is based on measurement data generated by one or more measurement entities responsive to respective one or more reference signals (e.g., see FIG. 5 and method 1100). The method includes, at 1220, generating a monitoring key performance indicator (KPI) based on the AI/ML data. The monitoring KPI may be an average value of the measurement data, a statistical distribution of the measurement data, or a statistical quantity related to a deviation between the measurement data and a ground truth value.

In some examples, as part of generating the monitoring KPI, the method includes deriving respective intermediate data from respective portions of the data set and generating the monitoring KPI based on the intermediate data. The method may include performing a statistical analysis of a subset of the AI/ML data to derive the intermediate data. In some examples, the method includes receiving successive data sets and logging, buffering and storing the data. When a threshold number of data sets has been received, the monitoring KPI is generated based on the successive data sets.

The method may include grouping the AI/ML data into groups and generating the monitoring KPI based on the groups. The grouping may be based on one or more of a reference signal associated with the AI/MVL data, a measurement device associated with the AI/ML data, a transmission time or range of transmission times for reference signals associated with the AI/MVL data.

The method includes, at 1230, providing the monitoring KPI to a network device acting as a monitoring comparison entity that monitors an AI/ML model used for AI-assisted positioning.

FIG. 13 is a flow diagram outlining an example method 1300 for causing generation of measurement data for AI/ML model monitoring purposes. The method 1300 may be performed by an entity implementing a monitoring comparison block (e.g., 482 of FIG. 4) and/or a network device acting as or implementing a monitoring entity (e.g., 480 of FIG. 4). For example, the method 1300 may be performed by a server or server function associated with an LMF or AI/MF, a UE, or a base station, or a distributed computing node.

The method 1300 includes, at 1310, receiving a monitoring KPI value derived from AI/ML data associated with an AI/ML model used for AI-assisted positioning. The monitoring KPI may be received from a statistics block of a monitoring entity (e.g., 478 of FIG. 4). The monitoring KPI may be an average value of measurement data, a statistical distribution of measurement data, or a statistical quantity related to a deviation between the AI/ML data and a reference value for the AI/ML data. The monitoring KPI may be derived from inference data output by the AI/ML model.

The method includes, at 1320, comparing the monitoring KPI to a reference KPI. The method may include deriving the reference KPI based on training data associated with the AI/ML model. The method may include determining a ground truth value for use as the reference KPI. The ground truth value may be determined based on a position of the network device as determined by a global navigation satellite system (GNSS).

The method includes, at 1330, performing one or more monitoring actions based on the comparison. The one or more monitoring actions may include triggering a re-training of the AI/ML model, selection of a different AI/ML model, or ceasing use of AI assisted positioning.

Above are several flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

Examples herein can include subject matter such as a method, means for performing acts or blocks of the method, at least one machine-readable medium including executable instructions that, when performed by a machine or circuitry (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is an apparatus for a network device, including a memory and a processor coupled to the memory, the processor configured to, when executing instructions stored in the memory, cause the network device to cause one or more measurement entities to measure reference signals and generate measurement data for use in monitoring an artificial intelligence/machine learning (AI/ML) model used for AI-assisted positioning; and monitor a performance of the AI/ML model based on the measurement data.

Example 2 includes the subject matter of example 1, including or omitting optional elements, wherein the reference signals are transmitted on a preconfigured periodic, aperiodic, or pseudo-periodic basis.

Example 3 includes the subject matter of example 2, including or omitting optional elements, the processor configured to cause the network device to transmit a configuration of the reference signals to one or more reference signal entities, wherein the configuration configures the reference signals on a periodic, aperiodic, or pseudo-periodic basis.

Example 4 includes the subject matter of example 1, including or omitting optional elements, the processor configured to cause the network device to transmit a physical layer request for the reference signals to one or more reference signal entities.

Example 5 includes the subject matter of example 1, including or omitting optional elements, wherein the measurement data is used by the AI/ML model to generate inference results.

Example 6 includes the subject matter of example 1, including or omitting optional elements, the processor configured to cause the network device to configure the one or more measurement entities to accumulate measurement data collected in response to multiple reference signals and transmit the accumulated measurement data to the network device.

Example 7 includes the subject matter of example 1, including or omitting optional elements, the processor configured to cause the network device to trigger one or more reference signal entities to transmit multiple reference signals; and trigger the one or more measurement entities to measure the multiple reference signals.

Example 8 includes the subject matter of example 1, including or omitting optional elements, wherein the measurement data includes a reference signal received power (RSRP) or signal to interference and noise ratio (SINR) of a reference signal, a delay spread between multiple reference signals, or a Doppler shift of a reference signal, a channel impulse response (CIR) of a reference signal, Power Delay Profile (PDP) of a reference signal, time of arrival (TOA) of a reference signal, angle of arrival (AOA) of a reference signal.

Example 9 is an apparatus for a network device including a memory and a processor coupled to the memory, the processor configured to, when executing instructions stored in the memory: cause the network device to receive a data set including artificial intelligence/machine learning (AI/ML) data, respective AI/ML data in the data set based on measurement data generated by one or more measurement entities responsive to respective one or more reference signals; generate a monitoring key performance indicator (KPI) based on the AI/ML data; and provide the monitoring KPI to a network device acting as a monitoring comparison entity that monitors an AI/ML model used for AI-assisted positioning.

Example 10 includes the subject matter of example 9, including or omitting optional elements, wherein the processor is configured to derive respective intermediate data from respective portions of the data set; and generate the monitoring KPI based on the intermediate data.

Example 11 includes the subject matter of example 10, including or omitting optional elements, wherein the processor is configured to derive the intermediate data by performing a statistical analysis of a subset of the AI/ML data.

Example 12 includes the subject matter of example 10, including or omitting optional elements, the processor configured to cause the network device to monitor for scenario change notification signals indicative of a time at which an operating scenario change occurred; and derive the intermediate data based any received scenario change notification signals.

Example 13 includes the subject matter of example 9, including or omitting optional elements, wherein the measurement data includes a reference signal received power (RSRP) or signal to interference and noise ratio (SINR) of a reference signal, a delay spread between multiple reference signals, or a Doppler shift of a reference signal, a channel impulse response (CIR) of a reference signal, Power Delay Profile (PDP) of a reference signal, time of arrival (TOA) of a reference signal, angle of arrival (AOA) of a reference signal.

Example 14 includes the subject matter of example 9, including or omitting optional elements, wherein the processor is configured to cause the network device to receive successive data sets; and wherein the processor is configured to generate the monitoring KPI using the received successive data sets when a threshold number of data sets has been received.

Example 15 includes the subject matter of example 9, including or omitting optional elements, wherein the processor is configured to group the AI/ML data into groups and generate the monitoring KPI based on the groups, wherein the grouping is based on one or more of a reference signal associated with the AI/ML data, a measurement device associated with the AI/ML data, a transmission time or range of transmission times for reference signals associated with the AI/ML data.

Example 16 includes the subject matter of example 9, including or omitting optional elements, wherein the monitoring KPI includes an average value of the measurement data, a statistical distribution of the measurement data, or a statistical quantity related to a deviation between the measurement data and a ground truth value.

Example 17 includes the subject matter of example 9, including or omitting optional elements, wherein measurement data includes inference data generated by the AI/ML model.

Example 18 is an apparatus for a network device including a memory and a processor coupled to the memory, the processor configured to, when executing instructions stored in the memory: receive a monitoring KPI derived from AI/ML data associated with an AI/ML model used for AI-assisted positioning; compare the monitoring KPI to a reference KPI; and based on the comparison, perform one or more monitoring actions.

Example 19 includes the subject matter of example 18, including or omitting optional elements, wherein the monitoring KPI includes an average value of measurement data, a statistical distribution of measurement data, or a statistical quantity related to a deviation between the AI/ML data and a reference value for the AI/ML data.

Example 20 includes the subject matter of example 18, including or omitting optional elements, wherein the reference KPI is derived from training data associated with the AI/ML model.

Example 21 includes the subject matter of example 18, including or omitting optional elements, wherein the monitoring KPI is derived from inference data output by the AI/ML model.

Example 22 includes the subject matter of example 18, including or omitting optional elements, wherein the processor is configured to cause the network device to determine, as the reference KPI, a ground truth value; and compare the monitoring KPI to the ground truth value.

Example 23 includes the subject matter of example 22, including or omitting optional elements, wherein the processor is configured to cause the network device to determine the ground truth value based on a position of the network device as determined by a global navigation satellite system (GNSS), a radio access technology (RAT)-based positioning method, a known position of the network device, or synthetic data generated from augmented input data.

Example 24 includes the subject matter of example 18, including or omitting optional elements, wherein the one or more monitoring actions include triggering a full or fine re-training of the AI/ML model, selection of a different AI/ML model, de-activating AI assisted positioning, or signaling a decision entity based on the comparison.

Example 25 is a UE including the apparatus of any of claims 1-24.

Example 26 is a base station including the apparatus of any of claims 1-24.

Example 27 is an artificial intelligence/machine learning management function (AI/ML-MF) server including the apparatus of any of claims 1-24.

Example 28 is a location management function (LMF) server including the apparatus of any of claims 1-24.

Example 29 is a method including performing functions performed by the network device of any of claims 1-23.

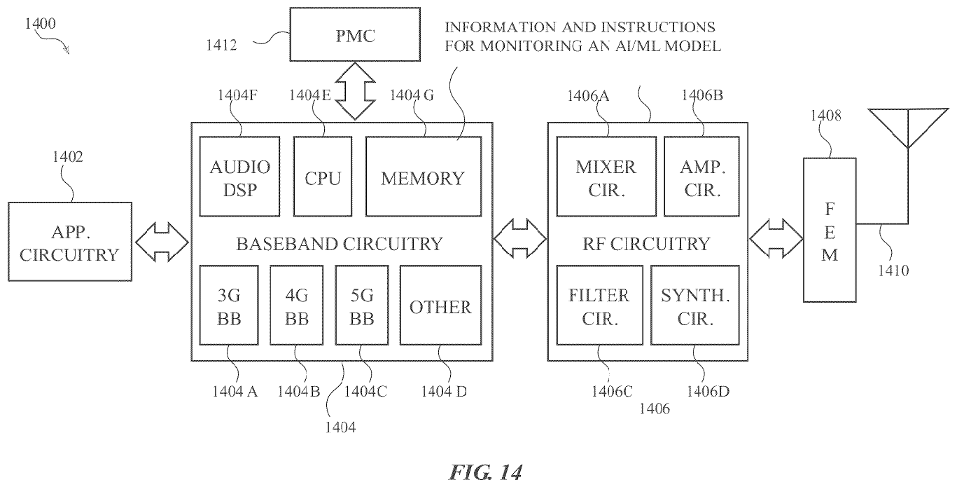

FIG. 14 is a diagram of an example of components of a network device according to one or more implementations described herein. In some implementations, the device 1400 can include application circuitry 1402, baseband circuitry 1404, RF circuitry 1406, front-end module (FEM) circuitry 1408, one or more antennas 1410, and power management circuitry (PMC) 1412 coupled together at least as shown. The components of the illustrated device 1400 can be included in a UE or a RAN node. In some implementations, the device 1400 can include fewer elements (e.g., a RAN node may not utilize application circuitry 1402, and instead include a processor/controller to process IP data received from a CN or an Evolved Packet Core (EPC)). In some implementations, the device 1400 can include additional elements such as, for example, memory/storage, display, camera, sensor (including one or more temperature sensors, such as a single temperature sensor, a plurality of temperature sensors at different locations in device 1400, etc.), or input/output (I/O) interface. In other implementations, the components described below can be included in more than one device (e.g., said circuitries can be separately included in more than one device for Cloud-RAN (C-RAN) implementations).

The application circuitry 1402 can include one or more application processors. For example, the application circuitry 1402 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1400. In some implementations, processors of application circuitry 1402 can process IP data packets received from an EPC. In some implementations, the application circuitry 1402 may generate a request for a position from a positioning service or server and receive an AI-assisted (e.g., based at least in part on inference data) position from the positioning service.

The baseband circuitry 1404 can include circuitry such as, but not limited to, one or more single-core or multi-core processors. The baseband circuitry 1404 can include one or more baseband processors or control logic to process baseband signals received from a receive signal path of the RF circuitry 1406 and to generate baseband signals for a transmit signal path of the RF circuitry 1406. Baseband circuitry 1404 can interface with the application circuitry 1402 for generation and processing of the baseband signals and for controlling operations of the RF circuitry 1406. For example, in some implementations, the baseband circuitry 1404 can include a 3G baseband processor 1404A, a 4G baseband processor 1404B, a 5G baseband processor 1404C, or other baseband processor(s) 1404D for other existing generations, generations in development or to be developed in the future (e.g., 5G, 6G, etc.).

The baseband circuitry 1404 (e.g., one or more of baseband processors 1404A-D) can handle various radio control functions that enable communication with one or more radio networks via the RF circuitry 1406. In other implementations, some or all of the functionality of baseband processors 1404A-D can be included in modules stored in the memory 1404G and executed via a Central Processing Unit (CPU) 1404E. In some implementations, the baseband circuitry 1404 can include one or more audio digital signal processor(s) (DSP) 1404F.

In some implementations, the memory 1404G stores information and instructions that allow the network device to function as any one or more of the entities (e.g., RS, measurement, model configuration, model, data collection, monitoring, and so on) illustrated in FIG. 4. When the network device is acting as the model entity, the memory 1404G also stores the AI/ML model. In some implementations, memory 1404G may receive and/or store information and instructions for monitoring an AI/ML model. The information and instructions enable the network device to function as a monitoring entity as illustrated in FIG. 4.

RF circuitry 1406 can enable communication with wireless networks using modulated electromagnetic radiation through a non-solid medium. In various implementations, the RF circuitry 1406 can include switches, filters, amplifiers, etc. to facilitate the communication with the wireless network. RF circuitry 1406 can include a receive signal path which can include circuitry to down-convert RF signals received from the FEM circuitry 1408 and provide baseband signals to the baseband circuitry 1404. RF circuitry 1406 can also include a transmit signal path which can include circuitry to up-convert baseband signals provided by the baseband circuitry 1404 and provide RF output signals to the FEM circuitry 1408 for transmission.

In some implementations, the receive signal path of the RF circuitry 1406 can include mixer circuitry 1406A, amplifier circuitry 1406B and filter circuitry 1406C. In some implementations, the transmit signal path of the RF circuitry 1406 can include filter circuitry 1406C and mixer circuitry 1406A. RF circuitry 1406 can also include synthesizer circuitry 1406D for synthesizing a frequency for use by the mixer circuitry 1406A of the receive signal path and the transmit signal path.

Examples herein can include subject matter such as a method, means for performing acts or blocks of the method, at least one machine-readable medium including executable instructions that, when performed by a machine or circuitry (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases. In some embodiments, the methods illustrated above may be implemented in a computer readable medium using instructions stored in a memory. Many other embodiments and variations are possible within the scope of the claimed disclosure.

The term “couple” is used throughout the specification. The term may cover connections, communications, or signal paths that enable a functional relationship consistent with the description of the present disclosure. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A device, comprising a memory and a processor coupled to the memory, the processor configured to, when executing instructions stored in the memory, cause the device to:
cause a measurement entity to generate, based on measurement of a reference signal, measurement data for use in monitoring an artificial intelligence/machine learning (AI/ML) model used for AI-assisted positioning; and
monitor a performance of the AI/ML model based on the measurement data.

2. The device of claim 1, wherein the reference signal is transmitted on a preconfigured periodic, aperiodic, or pseudo-periodic basis.

3. The device of claim 2, the processor configured to cause the device to transmit a configuration of the reference signal to one or more reference signal entities, wherein the configuration configures the reference signal on a periodic, aperiodic, or pseudo-periodic basis.

4. The device of claim 1, the processor configured to cause the device to transmit a physical layer request for the reference signal to a reference signal entity.

5. The device of claim 1, wherein the measurement data is used by the AI/ML model to generate an inference result.

6. The device of claim 1, the processor configured to cause the device to configure the measurement entity to
accumulate measurement data collected in response to multiple reference signals, and transmit the accumulated measurement data to the device.

7. The device of claim 1, the processor configured to cause the device to:
trigger one or more reference signal entities to transmit multiple reference signals; and
trigger the one or more measurement entities to measure the multiple reference signals.

8. The device of claim 1, wherein the measurement data comprises a reference signal received power (RSRP) or signal to interference and noise ratio (SINR) of a reference signal, a delay spread between multiple reference signals, or a Doppler shift of a reference signal, a channel impulse response (CIR) of a reference signal, Power Delay Profile (PDP) of a reference signal, time of arrival (TOA) of a reference signal, angle of arrival (AOA) of a reference signal.

9. A processor configured to, when executing instructions stored in a memory, perform operations, comprising:
causing a device to receive a data set comprising artificial intelligence/machine learning (AI/ML) data, respective AI/ML data in the data set based on measurement data generated by a measurement entity responsive to a reference signal;
generating a monitoring key performance indicator (KPI) based on the AI/ML data; and
causing the device to provide the monitoring KPI to a device acting as a monitoring comparison entity that monitors an AI/ML model used for AI-assisted positioning.

10. The processor of claim 9, wherein the operations comprise:
deriving respective intermediate data from respective portions of the data set; and
generating the monitoring KPI based on the intermediate data.

11. The processor of claim 10, wherein the operations comprise deriving the intermediate data by performing a statistical analysis of a subset of the AI/ML data.

12. The processor of claim 10, wherein the operations comprise
causing the device to monitor for a scenario change notification signal indicative of a time at which an operating scenario change occurred; and
deriving the intermediate data based any received scenario change notification signal.

13. The processor of claim 10, wherein the measurement data comprises a reference signal received power (RSRP) or signal to interference and noise ratio (SINR) of a reference signal, a delay spread between multiple reference signals, or a Doppler shift of a reference signal, a channel impulse response (CIR) of a reference signal, Power Delay Profile (PDP) of a reference signal, time of arrival (TOA) of a reference signal, angle of arrival (AOA) of a reference signal.

14. The processor of claim 9, wherein the operations comprise
causing the device to receive successive data sets; and
generating the monitoring KPI using the received successive data sets when a threshold number of data sets has been received.

15. The processor of claim 9, wherein measurement data includes inference data generated by the AI/ML model.

16. A device comprising a memory and a processor coupled to the memory, the processor configured to, when executing instructions stored in the memory, cause the device to:
receive a monitoring KPI derived from AI/ML data associated with an AI/ML model used for AI-assisted positioning;
compare the monitoring KPI to a reference KPI; and
based on the comparison, perform one or more monitoring actions.

17. The device of claim 16, wherein the reference KPI is derived from training data associated with the AI/ML model.

18. The device of claim 16, wherein the monitoring KPI is derived from inference data output by the AI/ML model.

19. The device of claim 16, wherein the processor is configured to cause the device to:
determine, as the reference KPI, a ground truth value; and
compare the monitoring KPI to the ground truth value.

20. The device of claim 16, wherein the one or more monitoring actions comprise triggering a full or fine re-training of the AI/ML model, selection of a different AI/ML model, de-activating AI assisted positioning, or signaling a decision entity based on the comparison.
